(19) United States
(12) Patent Application Publication
(10) Pub. No.: US 2008/0278966 A1
(43) Pub. Date: Nov. 13, 2008

(54) LED Light String

(76) Inventor: Xuliang Li, Dongguan (CN)

Correspondence Address: GLOBAL IP SERVICES, 7285 W. Eagle Court, Winton, CA, 95388, US

(21) Appl. No.: 11/830,209

(22) Filed: Jul. 30, 2007

(30) Foreign Application Priority Data
May 10, 2007 (CN) 200720119898.X

(51) Int. Cl. F21S 4/00; H01R 33/00

(52) U.S. Cl. 362/653; 315/185 S

(57) ABSTRACT

The present invention relates to decorative lights, and more particularly to an LED light string with a safety device. The LED light string includes an electrical plug, lead wires, and LED bulbs, and further includes a safety device connected with the LED bulbs in series. The safety device has a temperature fuse tube and a heating resistance which are connected in series and form two lead pins after connected. The temperature fuse tube and the heating resistance are jointed together so as to transfer heat therebetween. The temperature fuse tube and the heating resistance are encapsulated in a shell. The shell provides two terminals therein. The two lead pins are connected with the two terminals respectively, and the two terminals are connected with the respective lead wires to form a circuit loop. The shell is an assembled shell.

### CROSS REFERENCE TO RELATED PATENT APPLICATION

This patent application claims the priority of the Chinese patent application No. 200720119898.X, filing date of May 10, 2007.

### FIELD OF THE INVENTION

The present invention relates to decorative lights, and more particularly to an LED (light emitting diode) light string with a safety device.

### BACKGROUND OF THE INVENTION

Decorative lights are used frequently in our daily life, especially on the festivals. Many kinds of decorative light strings are widely used as Christmas light ornaments and building ornaments. LED light string composed of LED bulbs is the most popularly used kind. The LED bulbs are likely to be broken down and thus to cause the current in the light string to increase dramatically. The increased current may cause the heating power of the current limiting resistance connected in series in the light string to exceed its designed rating. This may result in the hidden safety trouble of melting down or self-igniting of the resistance shell.

Hence, a need has arisen for providing an improved LED light string to solve the above-mentioned problem.

### SUMMARY OF THE INVENTION

Accordingly, an objective of the present invention is to provide an LED light string with a safety device to overcome the shortage of the above-mentioned prior art, which is capable of avoiding the hidden safety trouble of the LED light string.

To achieve the above-mentioned objective, an LED light string comprises an electrical plug, a plurality of lead wires and a plurality of LED bulbs, and further comprises a safety device connected with the LED bulbs in series. The safety device comprises a temperature fuse tube and a heating resistance. The temperature fuse tube and the heating resistance are connected in series and form two lead pins after connected. The temperature fuse tube and the heating resistance are jointed together so as to transfer heat therebetween, and the temperature fuse tube and the heating resistance are encapsulated in a shell. The shell provides two terminals therein. The two lead pins are connected with the two terminals respectively, and the two terminals are connected with the respective lead wires to form a circuit loop. The shell is an assembled shell comprising a tube-shaped body and a tube-shaped head cover with one end thereof closed. An inner core is provided in the body. The temperature fuse tube and the heating resistance are integrated with the inner core so as to be made into a whole, and the whole is disposed in the shell. The inner core has a pin-insertion hole. The lead pins run through the pin-insertion hole and then folded back to connect with the respective terminals. The body and the head cover are fastened by a buckle.

The temperature fuse tube and the heating resistance are jointed with each other through a heat conductive piece.

The temperature fuse tube and the heating resistance are joined with each other through silica gel having good heat conductive performance.

The body and the head cover are fastened by an inseparable one-off buckle.

There is only one safety device in each series circuit loop of the LED light string.

In the LED light string according to the present invention, the temperature fuse tube and the heating resistance are connected in series and encapsulated in the shell. The temperature fuse tube and the heating resistance are jointed with each other. The quantity of heat of the heating resistance varies in accordance with the variation of the current in the LED light string. The temperature fuse tube is jointed with the heating resistance to induce the temperature of the heating resistance so that the temperature fuse tube will cut the circuit loop when the temperature of the heating resistance rises to a predetermined value. The temperature fuse tube of the present invention may be one-off fuse tube or restoration fuse tube.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

FIG. 1 is a schematic view of a first embodiment of an LED light string according to the present invention.

FIG. 2 is a cross-sectional view of a safety device of the LED light string shown in FIG. 1.

### DETAILED DESCRIPTION OF ILLUSTRATED EMBODIMENTS

Various preferred embodiments of the invention will now be described with reference to the figures, wherein like reference numerals designate similar parts throughout the various views.

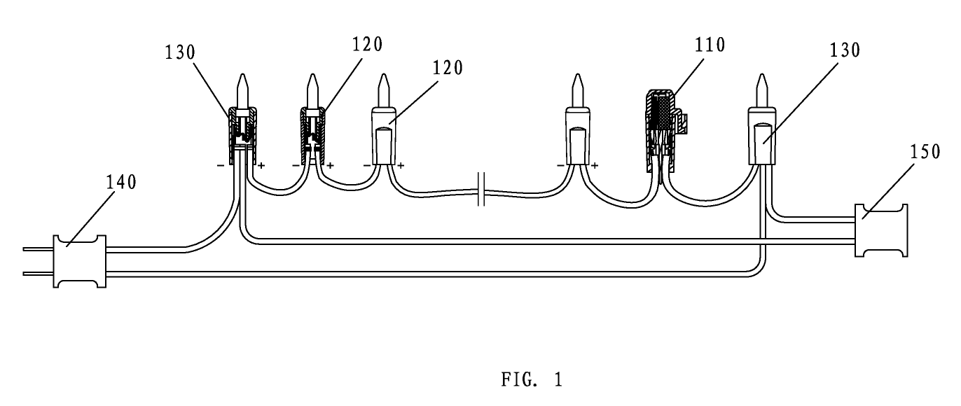

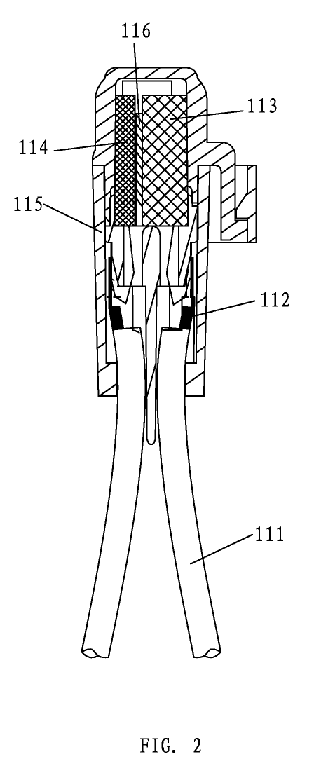

Referring to FIG. 1 and FIG. 2, a first embodiment of the present invention is an LED light string with a tail plug 150, which includes an electrical plug 140, lead wires 111, LED bulbs 120, and further includes a safety device 110 which is connected with the LED bulbs 120 in series. The safety device 110 includes a temperature fuse tube 114 and a heating resistance 113. The temperature fuse tube 114 and the heating resistance 113 are connected in series, and form two lead pins after connected. The temperature fuse tube 114 and the heating resistance 113 are jointed together through a heat conductive piece 116 so as to contact adequately, thereby transferring heat therebetween. The temperature fuse tube 114 and the heating resistance 113 are encapsulated in a shell 115. The shell 115 provides two terminals 112 therein. The two lead pins are connected with the two terminals 112 respectively, and the two terminals 112 are connected with the respective lead wires to form a circuit loop. The shell 115 is an assembled shell including a tube-shaped body, a tube-shaped head cover with one end thereof closed. An inner core is provided in the body. The temperature fuse tube 114 and the heating resistance 113 are integrated with the inner core so as to be made into a whole, and the whole is disposed in the shell 115. The inner core has a pin-insertion hole. The lead pins of the fuse tube 114 run through the pin-insertion hole of the inner core and then are folded back to connect with the respective terminals 112 to form the above-mentioned connection. Referring to FIG. 2, the body and the head cover are fastened by an inseparable one-off buckle. The LED light string of the present embodiment further includes a tail plug 150 configured to plug into the next LED light string. The tail pin 150 has an output jack and two input lead wires connected with two electrical source wires of the electrical plug 140 of the LED light string respectively. The actual connection method is that the first and the last LED bulbs of the LED light string employ LED bulbs 130 connected with three lead wires. One terminal of the LED bulb 130 has two lead wires disposed thereon, referring to FIG. 1, which are connected with the plug 140 and the tail plug 150 respectively, while the other terminal of the LED light 130 has one lead wire disposed thereon, which is connected with the adjacent LED light 120. In the present embodiment, the safety device 110 is connected between the first LED light 130 and the second LED light 120 counted from the tail end of the LED light string.

In the present invention, the temperature fuse tube and the heating resistance may be jointed together directly without heat conductive piece. The body and the head cover may be fastened by a knock-down buckle. The above-mentioned variations are all in the scope of the present invention.

What is claimed is:

1. An LED light string comprising:
an electrical plug;
a plurality of lead wires;
a plurality of light emitting diode bulbs; and
a safety device connected in series with the light emitting diode bulbs, the safety device comprising a temperature fuse tube and a heating resistance;
wherein the temperature fuse tube and the heating resistance are connected in series and form two lead pins after connected, the temperature fuse tube and the heating resistance are jointed together so as to transfer heat therebetween, and the temperature fuse tube and the heating resistance are encapsulated in a shell;
wherein the shell provides two terminals therein, the two lead pins are connected with the two terminals respectively, and the two terminals are connected with the respective lead wires to form a circuit loop;
wherein the shell is an assembled shell comprising a tube-shaped body and a tube-shaped head cover with one end thereof closed, an inner core is provided in the body, the temperature fuse tube and the heating resistance are integrated with the inner core so as to be made into a whole, and the whole is disposed in the shell;
wherein the inner core has a pin-insertion hole, the lead pins run through the pin-insertion hole and then are folded back to connect with the respective terminals;
wherein the body and the head cover are fastened by a buckle.

2. The LED light string as claimed in claim 1, wherein the temperature fuse tube and the heating resistance are jointed with each other through a heat conductive piece.

3. The LED light string as claimed in claim 1, wherein the temperature fuse tube and the heating resistance are jointed with each other through silica gel having good heat conductive performance.

4. The LED light string as claimed in claim 1, wherein the body and the head cover are fastened by an inseparable one-off buckle.

5. The LED light string as claimed in claim 1, wherein there is only one safety device in each series circuit loop of the LED light string.
